(19) United States
(12) Patent Application Publication
(10) Pub. No.: US 2014/0342266 A1
(43) Pub. Date: Nov. 20, 2014

(54) FUEL CELL INCLUDING COUPLING DEVICE

(71) Applicant: DOOSAN HEAVY INDUSTRIES & CONSTRUCTION CO., LTD., Changwon-si (KR)

(72) Inventors: Seungryoon Lee, Daejeon (KR); Dongwoo Kang, Daejeon (KR); Woonyong Choi, Gyoang-si (KR); Youngbong Kim, Daejeon (KR); Jinheouck Jun, Yongin-si (KR); Yunsung Kim, Daejeon (KR); Ingab Chang, Daejeon (KR); Taewon Lee, Daejeon (KR)

(73) Assignee: DOOSAN HEAVY INDUSTRIES & CONSTRUCTION CO., LTD., Changwon-si (KR)

(21) Appl. No.: 14/369,848

(22) PCT Filed: Dec. 28, 2012
(86) PCT No.: PCT/KR2012/011723

§ 371 Date: Jun. 30, 2014

(30) Foreign Application Priority Data
Dec. 30, 2011 (KR) 10-2011-0147798
Dec. 28, 2012 (KR) 10-2012-0155784

(51) Int. Cl. H01M 8/24; H01M 8/14

(52) U.S. Cl. CPC H01M 8/2485; H01M 8/144; H01M 2008/147
USPC 429/460

(57) ABSTRACT

A fuel cell including a coupling device according to the present invention is configured such that a fastening member for fastening a manifold to a stack is coupled to the manifold in such a manner that the fastening member directly contacts the manifold thus enabling the stack and the manifold to be flexible in reacting to a difference in the thermal deformation between the stack and the manifold, the fastening member having a predetermined cross-sectional area such that the fastening member cannot be easily thermally deformed by an environmental change, thus minimizing a degradation of the binding force of the fastening member. Furthermore, a portion of a frame of a first coupled unit is coupled independently of other frames, and therefore, a degradation of a coupling force of a certain frame is preemptively prevented from affecting other frames even when the degradation occurs during the operation of the fuel cell, thus preventing the coupling between the stack and the manifold from consequently being degraded. As a result, a sudden degradation of the fuel cell performance is prevented.

### TECHNICAL FIELD

The present invention relates to a fuel cell equipped with coupling devices including manifolds.

### BACKGROUND ART

In general, a fuel cell is a power generation apparatus that converts chemical energy according to the oxidization and reduction of a reactant into electrical energy. The fuel cell has almost no pollution and noise because only water (H₂O) is discharged as by-products unlike in other types of existing chemical energy, and has been in the spotlight as the next-generation alternative energy because it has a simple reaction.

In particular, a Molten Carbonate Fuel Cell (MCFC) of fuel cells has an operating temperature of 600° C. or more because it uses the melt of a carbonate as an electrolyte, does not require a novel metal catalyst, such as platinum unlike a low-temperature type fuel cell because it has a fast electrochemical reaction speed, and enables combined cogeneration power generation because it may expect heat efficiency of 60% or more if the MCFC is used along with electricity and a high temperature.

A unit cell of the MCFC includes an anode and cathode in which an electrochemical reaction is generated, a separation plate that forms the flow channel of a fuel gas and an oxidizer gas, a collector plate that collects charges, an electrolyte plate fabricated in a sheet form for convenience of stacking, and a matrix that accommodates a molten carbonate.

In such an MCFC, when a fuel gas is supplied to the anode and an oxidizer gas is supplied to the cathode, an electrochemical reaction is generated between the electrodes, thereby generating DC power.

Voltage of such a unit cell is low, that is, about 0.8 to 1.2 V, at the time of rating discharge. Thus, in actual power generation, a plurality of the unit cells is stacked in order to raise voltage, and a cell area is extended in order to achieve high output. To stack multiple stages of the unit cells is called a stack.

Furthermore, a manifold that accommodates the entrance/exit of the anode and cathode is coupled with the side of the stack. Since the fuel gas and the oxidizer gas flow in a flow channel formed by the stack and the manifolds, airtightness needs to be maintained between the stack and the manifolds, and electrical insulation needs to be maintained between the unit cells.

Furthermore, in the MCFC, an internal temperature maintains a high temperature of about 650° C. upon pre-processing and operation, and a variation in a plane temperature within the cell is 100° C. or more. Accordingly, the thermal expansion of metal structures within the stack, the thermal expansion of elements, and a change of physical properties are generated.

Accordingly, since there is a difference in the deformation of the stack and the manifolds, surfaces where the stack and the manifolds come in contact with each other need to be coupled in such a way as to stably slide depending on the degree of relative deformation. In this case, airtightness between the stack and the manifolds can be maintained. In particular, the stack of about 300 kW has a stack height of 4 m or more, and thus the length of the manifolds is long that much. Accordingly, the stack and the manifolds need to be combined so that they flexibly handle the deformation of the stack and the manifolds.

A coupling method using a wire beam, disclosed in U.S. Pat. No. 6,461,756, has been known as a conventional manifold coupling method. In this method, the circumference of manifolds is surrounded with wire beams and one ends of the wire beams are coupled by a spring so that binding force can be maintained in all the manifolds.

However, such a conventional manifold coupling method was problematic in that binding force at a high temperature may be greatly reduced because the thermal expansion of the wire beams at a high temperature is great and sliding between the wire and the structure is not smooth, the adhesion force of the manifolds are low, the performance of the fuel cell is low due to the leakage of fuel.

Furthermore, there was a problem in that the performance of the stack is deteriorated because a coupling state on the other side is also poor if a coupling state on any one side is poor because the entrance side and exit side of the anode and the entrance side and the exit side of the cathode in the stack are coupled so that they are connected.

### DISCLOSURE

### Technical Problem

An object of the present invention is to provide a fuel cell equipped with coupling devices, wherein thermal deformation between a stack and manifolds can be flexibly handled and adhesion force between the stack and the manifolds can be closely maintained because a fastening member itself is prevented from being thermally deformed.

Another object of the present invention is to provide a fuel cell equipped with coupling devices, wherein at least one of the coupling faces of a stack and manifolds is coupled independently of other faces, thereby being capable of preventing the coupling states of the stack and the manifolds from continuously becoming poor.

### Technical Solution

To achieve the above objects, there may be provided a fuel cell equipped with coupling devices, including a stack in which a plurality of unit cells having an anode and a cathode is stacked in the height direction, the entrance and exit of the anode are formed on both sides in a first direction, and the entrance and exit of the cathode are formed on both sides in a second direction orthogonal to the first direction; an upper end plate and a lower end plate provided at both upper and lower ends of the stack; a plurality of manifolds closely attached and coupled to the sides of the stack so that fuel and air supplied to the stack are distributed into the unit cells; first coupling units that closely attach the manifolds to the upper end plate and the lower plate; and second coupling units that closely attach the manifolds to the stack, wherein the first coupling units have a plurality of frames detachable from the manifolds interconnected by fastening members, and the second coupling units have a plurality of frames fixed to the manifolds interconnected by fastening members.

In this case, the fastening members may be coupled to both ends of one of the plurality of frames so that the one frame is coupled independently of other frames.

Furthermore, support units bent in a direction where two frames of the plurality of frames other than the independently coupled frame face each other may be formed at the ends of each of the two frames, and both ends of the frame having the support units may be coupled by a fastening member that passes through both sides of the end plate.

Furthermore, an insertion groove may be formed in the independently couple frame so that a fastening bolt forming the fastening member is inserted into the insertion groove.

Furthermore, wing units bent outwardly from the end plate may be formed on at least one of both ends of the independently coupled frame and the end of a frame corresponding to the independently coupled frame, and fastening members may be coupled to the respective wing units.

Furthermore, the wing units may be diagonally bent and formed so that inside surfaces of adjacent frames correspond to each other, and the fastening member may be coupled to the side of the end plate in a straight line.

Furthermore, in the second coupling unit, frames having a plurality of bars spaced apart from each other as a pair may be fixed to and installed on the outside surfaces of the manifolds, connection blocks connecting the plurality of bars may be installed at both ends of the frames, and the connection blocks may be coupled by the fastening members.

Furthermore, the fastening members may be coupled to the connection blocks between the plurality of bars.

Furthermore, at least one support face may be formed in at least one of the connection blocks so that the at least one support face is directly brought in contact with and supported to the stack or the manifolds.

Furthermore, a plurality of support faces may be formed in at least two of the connection blocks, and each of the plurality of support faces may be formed at a right angle.

Furthermore, the cross-sectional area of the bar may be formed to be smaller than the cross-sectional area of each frame of the first coupling unit.

Furthermore, the manifolds may be installed on the entrance side and exit side of the anode and the exit side of the cathode of the stack, each of the manifolds may include a housing unit that accommodates the entrance and exit of the anode and the exit of the cathode, the edge of the housing unit may have an edge unit so that the edge comes in contact with the stack, the upper end plate, and the lower end plate, the housing unit may be supported by the second coupling unit, and the edge unit may be supported by the first coupling unit.

Furthermore, the entrance side of the cathode may connect the entrance side and exit side of the anode using a single fastening member.

### Advantageous Effects

In the fuel cell equipped with coupling devices according to the present invention, a difference in thermal deformation between the stack and the manifolds can be flexibly handled because the fastening members that couple the manifolds to the stack are coupled to the manifolds in such a way as to come in a direct contact with the manifolds. Furthermore, a reduction of the binding force of the fastening member can be minimized because the fastening member is configured to have a specific cross-sectional area so that it is not easily thermally deformed according to a change of an environment.

Furthermore, the influence of a reduction in binding force on a specific frame while the fuel cell operates can be prevented from being transferred to other frames because some frames of the first coupling unit are coupled independently of other frames. Accordingly, the coupling states of the stack and the manifolds can be prevented from continuously becoming poor, and thus the performance of the fuel cell can be prevented from being suddenly reduced.

### DESCRIPTION OF DRAWINGS

FIG. 1 is a perspective view illustrating the manifold coupling apparatus of a fuel cell according to the present invention.

FIG. 2 is a perspective view illustrating the manifold coupling apparatus not including a stack in FIG. 1.

FIGS. 3 and 4 are enlarged views illustrating a part “A” and a part “B” of FIG. 2.

FIG. 5 is a lateral cross-sectional view illustrating that the third frame of a first coupling unit for closely attaching the edge unit of the manifold to an end plate in the fuel cell according to FIG. 2.

FIG. 6 is a plan view illustrating the state in which the third frame of the first coupling unit according to FIG. 5 has been combined.

FIG. 7 is a plan view illustrating a second coupling unit for closely attaching the housing unit of a manifold to the stack in the fuel cell according to FIG. 2.

### MODE FOR INVENTION

Hereinafter, a fuel cell equipped with coupling devices according to the present invention is described in detail based on an embodiment illustrated in the accompanying drawings.

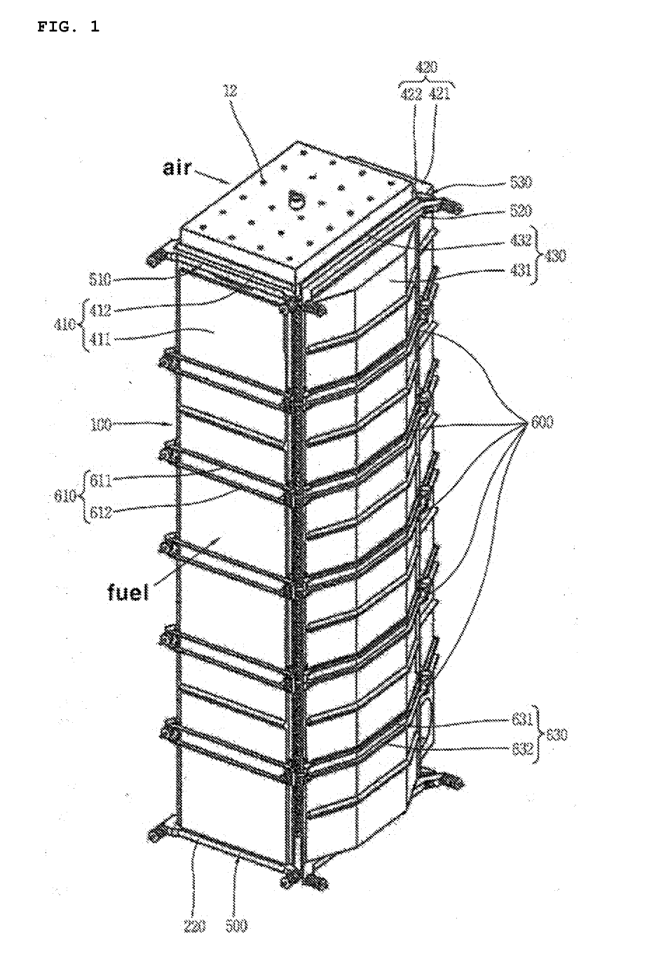

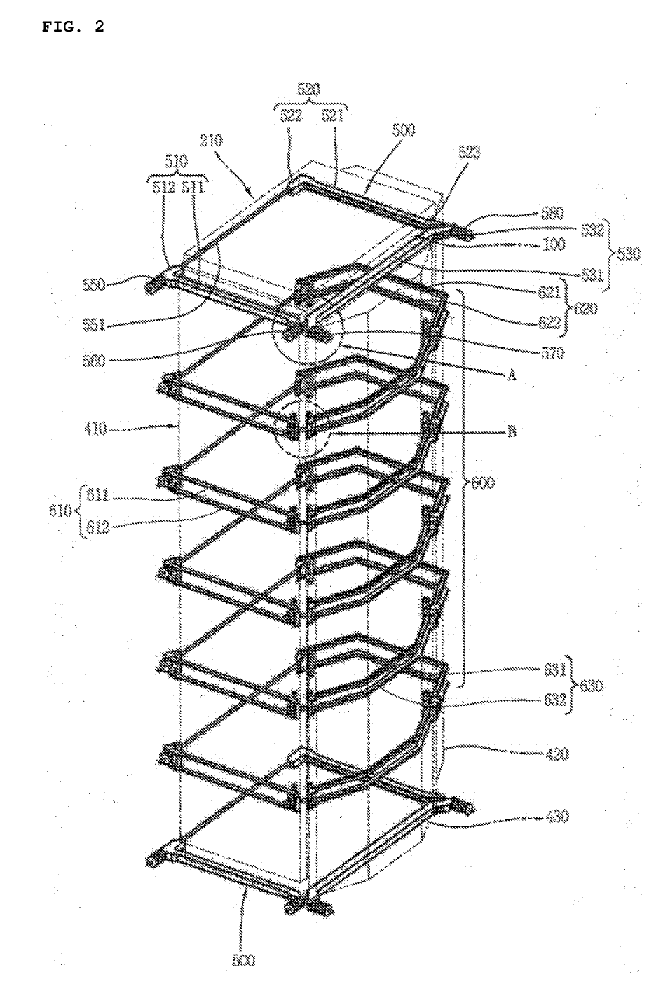

As illustrated in FIGS. 1 and 2, in the fuel cell according to the present embodiment, a plurality of unit cells (not illustrated) having the anode and the cathode may be stacked in the height direction, thus forming a stack 100. An upper end plate 200 and a lower end plate 300 for maintaining the stack state of the stack 100 may be coupled to the top and bottom of the stack 100.

The entrance/exit (not illustrated) of the anode and the entrance/exit (not illustrated) of the cathode formed in each unit cell may be formed in the sides of the stack 100. The entrance/exit of the anode and the exit of the cathode may be accommodated by manifolds 410, 420, and 430 installed in such a way as to be closely attached to the stack 100 and the upper and lower end plates 200 and 300.

In this case, the entrance and exit of the anode may be formed in a direction that is orthogonal to the direction, formed by the entrance and exit of the cathode, on a plane. Accordingly, the manifolds may be installed in all the four faces of the stack, but may be installed only on the entrance/exit sides of the anode and the exit side of the cathode as illustrated in FIGS. 1 and 2 without installing a separate manifold on the entrance side of the cathode. Hereinafter, a manifold installed on the entrance/exit sides of the anode is defined as the first manifold 410 and the second manifold 420, a manifold installed on the exit side of the cathode is defined as the third manifold 430, for convenience sake.

The first manifold 410 to the third manifold 430 each have an internal space so that they communicate with the entrance/exit of the anode and the exit of the cathode of the stack 100. Housing units 411, 421, and 431 supported to the stack 100 by means of a second coupling unit 600 to be described later may be formed at the center of the first manifold 410 to the third manifold 430, respectively. Edge units 412, 422, and 432 may be extended and formed from the open ends of the respective housing units 411, 421, and 431, and may be closely attached to the stack 100 and the upper and lower end plates 200 and 300 by means of a first coupling unit 500 to be described later. Accordingly, the housing units are spaced apart from the sides of the stack 100, whereas the edge units may be closely attached to the sides of the stack 100 and the sides of the upper and lower end plates 200 and 300.

As described above, the degree of deformation between each of the manifolds 410, 420, and 430 and the stack 100 when the fuel cell operates is different. Accordingly, the manifolds 410, 420, and 430 are unable to be fixed so that they do not move in relation to the stack 100 or the end plates 200 and 300, but need to be coupled to the stack 100 or the end plates 200 and 300 in such a way as to slide in the state in which the manifolds 410, 420, and 430 come in contact with the stack 100 or the end plates 200 and 300. Accordingly, in general, the manifolds 410, 420, and 430 may be coupled to the stack and the end plates by means of a coupling unit having elastic force.

The coupling unit may include an edge coupling unit (hereinafter the first coupling unit) 500 that surrounds the edge units of the manifolds on up and down and both sides and couples the edge units to the upper end plate 200 and the lower end plate 300 and a housing coupling unit (hereinafter the second coupling units) 600 that surrounds the housing units of the manifolds and couples the housing units to the stack.

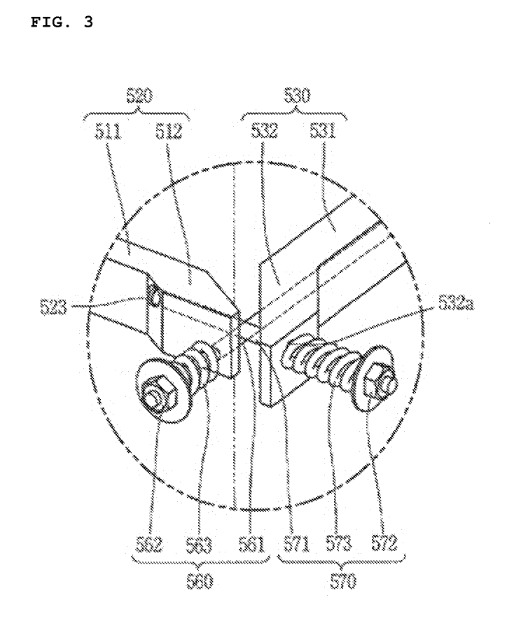

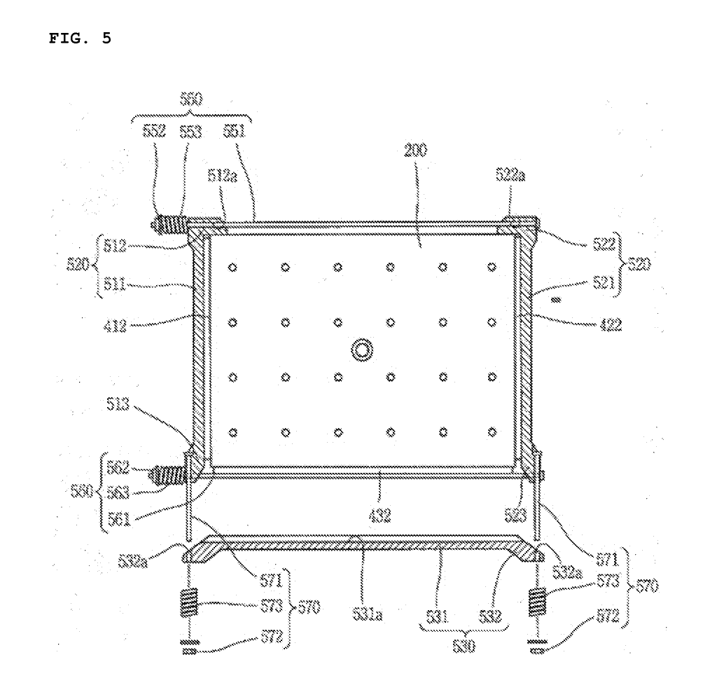

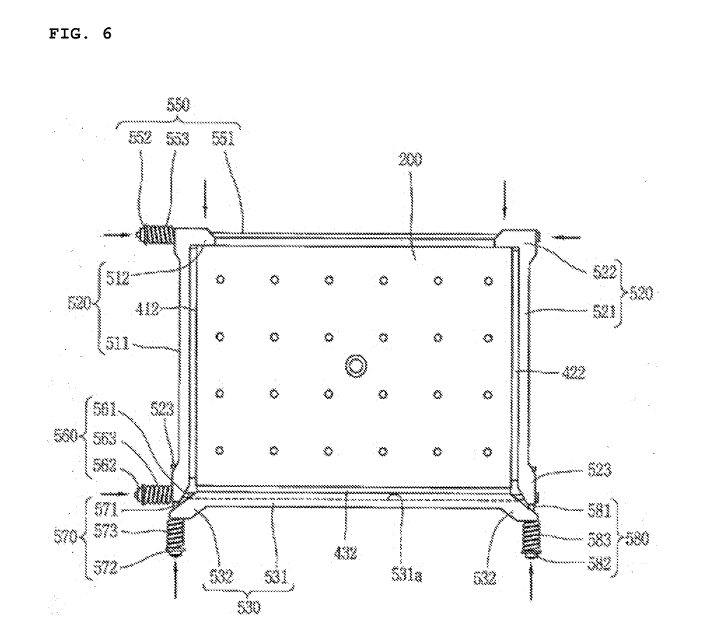

As illustrated in FIGS. 2 and 3 and 5 and 6, the first coupling unit 500 has a plurality of frames interconnected to form an approximately [symbol] shape when being projected on a plane, and may be coupled in such a way as to slide on a contact surface in the state in which the first coupling unit 500 has closely attached the upper edge units and lower edge units of each of the manifolds 410, 420, and 430 to the upper end plate 200 and the lower end plate 300. In this case, however, in the first coupling unit 500 according to the present embodiment, the first coupling unit that support the upper edge units and lower edge units of the manifolds 410, 420, and 430 are identically configured. Accordingly, the first coupling unit that supports the upper edge unit is described as a representative example, for convenience sake.

The first coupling unit 500 may include first to third frames 510, 520, and 530 that closely attach the first to the third manifolds 410, 420, and 430 to the sides of the upper end plate 200 by pressing the upper edge units of the respective first to third manifolds 410, 420, and 430. Hereinafter, frames corresponding to the entrance/exit of the anode and the exit of the cathode are sequentially called the first, the second, and the third frames.

Furthermore, the first coupling unit 500 may include first to fourth fastening members 550, 560, 570, and 580 that connect the ends of the respective first to third frames 510, 520, and 530 and the ends of adjacent other frames. Hereinafter, the first, the second, the third, and the fourth fastening members 550, 560, 570, and 580 are connected between the entrance sides of the cathodes of the first frame 510 and the second frame 520, between the exit sides of the cathodes between the first frame 510 and the second frame 520, between the first frame 510 and the third frame 530, and between the second frame 520 and the third frame 530.

A first support unit 511 that presses the first manifold 410 to the entrance-side face (called a first side, for convenience sake) of the anode of the upper end plate 200 and supports the first manifold 410 thereto may be formed in a straight line in the first frame 510 on a plane. Furthermore, an end that belongs to both ends of the first support unit 511 and that is adjacent to the entrance side of the cathode not having a manifold may be bent at a right angle so that it supports the entrance side of the cathode face (call a fourth side, for convenience sake) of the upper end plate 200, thus forming a second support unit 512.

A through hole 512a or a through groove may be formed in the second support unit 512 so that a fastening bolt 551 forming the first fastening member 550 penetrates the through hole 512a or the through groove in the direction that connects the entrance side and exit side of the anode. Furthermore, a wing unit 513 to be described later is formed on the other side of the first frame 510, that is, at the end on the other side of the second support unit 512. A through groove or a through hole 513a is formed in the wing unit 513 so that the second fastening member 560 is able to penetrate the through groove or the through hole 513a in the direction of the second side (i.e., in the direction of the exit side of the anode). The fastening bolt 571 of the third fastening member 570 may be integrally extended and formed from the end of the wing unit 513, may be coupled to the wing unit 513 using a bolt, or may be fixed and coupled to the wing unit 513 using welding so that a fastening bolt 571 forming the third fastening member 570 is able to extended from the end of the wing unit 513 and inserted into the through hole 532a of the third frame 530 to be described later.

The second frame 520 may have the same shape as the first frame 510 so that it is symmetrical to the first frame 510.

A first support unit 531 that presses and supports the third manifold 430 to the exit side of the cathode face (called a third side, for convenience sake) of the upper end plate 200 may be formed in a straight line in the third frame 530 on a plane.

In this case, an insertion groove 531a inserted into a fastening bolt 561, forming the second fastening member 560, in the direction of the fourth side may be lengthily formed on the inside surface of the first support unit 531 so that the third frame 530 is pushed between the ends of the first frame 510 and the second frame 520 and then coupled to the first frame 510 and the second frame 520 on a plane.

Furthermore, through holes 532a or through grooves may be formed on both ends of the third frame 530 so that fastening bolts 571 and 581 forming the third fastening member 570 and the fourth fastening member 580 are able to penetrate the respective through holes 532a or through grooves in the direction of the fourth side.

In this case, wing units 532 that are outwardly curved may be formed at both ends of the third frame 530 so that the ends of the first frame 510 and the second frame 520 adjacent to both ends of the third frame 530 are prevented from being intervened when the third frame 530 is pushed between the first frame 510 and the second frame 520 after the first frame 510 and the second frame 520 are assembled depending on the assembly sequence. Wind units 513 and 523 may be formed in the first frame 510 and the second frame 520, respectively, so that they correspond to the inside surface of the wing unit 532 of the third frame 530.

The fastening members 550, 560, 570, and 580 may include respective fastening bolts 551, 561, 571, and 581 configured to connect the plurality of frames 510, 520, and 530, respective coupling nuts 552, 562, 572, and 582 coupled to one ends of the fastening bolts, that is, ends in which the heads of bolts are not formed, and respective fastening springs 553, 563, 573, and 583 provided between the frames and the coupling nuts and configured to elastically support corresponding manifolds and the sides of the upper end plate supported by corresponding frames.

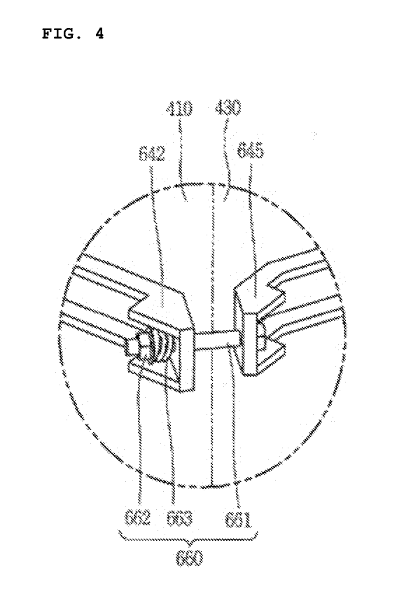

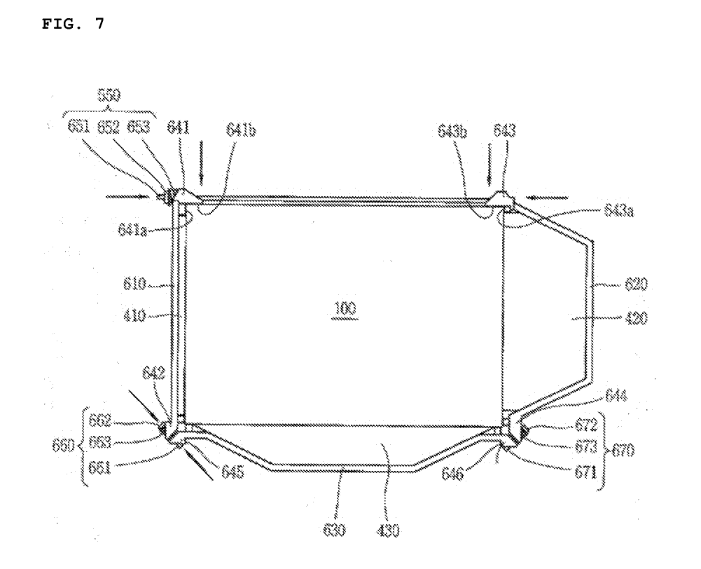

As illustrated in FIGS. 2, 4, and 7, in the second coupling unit 600, frames 610, 620, and 630 each formed of a pair of bars are fixed and coupled to the outside surfaces of the respective manifolds 410, 420, and 430. Connection blocks 641 to 646 are coupled to both ends of the frames 610, 620, and 630, and they connect adjacent frames and also press and support the side edge units of the manifolds 410, 420, and 430. The connection blocks 641 to 646 may be coupled by the respective fastening members 650, 660, and 670. In this case, on the entrance side of the cathode, a fastening bolt 651 that forms part of the first fastening member 650 like the first coupling unit 500 without having a separate frame passes through both sides and couples the first connection block 641 and the third connection block 643 to be described later.

In this case, a frame fixed to the first manifold 410 may be called a first frame 610, a frame fixed to the second manifold 420 may be called a second frame 620, and a frame fixed to the third manifold 430 may be called a third frame 630.

Furthermore, a connection block fixed to an end that belongs to both ends of the first frame 610 and that is adjacent to the entrance side of the cathode may be called a first connection block 641, the side opposite the first connection block 641 may be called a second connection block 642, a connection block adjacent to the entrance side of the cathode of the second frame 620 may be called a third connection block 643, the side opposite the third connection block 643 may be called a fourth connection block 644, a connection block that belongs to both ends of the third frame 630 and that is adjacent to the first frame 610 may be called a fifth connection block 645, and the side opposite the fifth connection block 645 may be called a sixth connection block 646.

Furthermore, a fastening member that couples the first connection block 641 and the third connection block 643 may be called a first fastening member 650, a fastening member that couples the second connection block 642 and the fifth connection block 645 may be called a second fastening member 660, and a fastening member that couples the fourth connection block 644 and the sixth connection block 646 may be called a third fastening member 670.

The bars (611, 612), (621, 622), and (631, 632) may be arranged at specific intervals in up and down directions, and the bars on both sides in up and down directions may be fixed and coupled to both ends of each of the connection blocks 641 to 646 in up and down directions. In this case, the cross-sectional area of one bar may be smaller than the cross-sectional area of the frames 510, 520, and 530 that form the first coupling unit 500.

A through hole (not having a reference numeral) may be formed at the center of each of the connection blocks 641 to 646 so that the fastening bolts 651, 661, and 671 forming the fastening members 650, 660, and 670 penetrate the respective through holes. Furthermore, the connection blocks 641 to 646 may be mostly formed in a flat panel form because they function to support the fastening members 650, 660, and 670 and to pressurize the side edge units of the manifolds 410, 420, and 430 laterally. In contrast, first support faces 641a and 643a and second support faces 641b and 643b may be formed in a ring angle form in the first connection block 641 and the third connection block 643, respectively, because the connection block itself needs to closely adhere to the entrance side of the cathode of the stack 100.

The first to the third fastening members 650, 660, and 670 may be formed to have the same shapes as the first to the fourth fastening members 550, 560, 570, and 580 of the first coupling unit 500.

Reference numerals 521 and 522 (not described) are first and second support units of the first frame of the first coupling unit, 522a and 523a into which the fastening bolts are inserted are through holes, 651, 661, and 671 are the first to the third fastening bolts, and 652, 662, and 672 are fastening nuts, and 653, 663, and 673 are fastening springs.

In the fuel cell equipped with coupling devices according to the present embodiment, the edge units 412, 422, and 432 on both sides of the manifolds 410, 420, and 430 in upper and lower direction may be fastened and coupled to the upper end plate 200 and the lower end plate 300 using the first coupling unit 500, and the housing units 411, 421, and 431 of the manifolds 410, 420, and 430 may be fastened and coupled to the stack 100 using the second coupling units 600.

More specifically, the first manifold 410, the second manifold 420, and the third manifold 430 are disposed on the entrance/exit sides of the anode and the exit side of the cathode, and are closely attached to the upper edge units and the lower edge units of the first manifold 410 and the second manifold 420 using the first support unit 511 of the first frame 510 of the first coupling unit 500 and the first support unit 521 of the second frame 520 of the first coupling unit 500.

Thereafter, the first coupling unit 500 fastens the first frame 510 and the second frame 520 using the fastening bolt 551 of the first fastening member 550 of the first coupling unit 500 and the fastening bolt 561 of the second fastening member 560 of the first coupling unit 500, so that both ends of the first manifold 410 and the second manifold 420 on the upper and lower parts are coupled to the upper end plate 200 and the lower end plate 300 by means of the first support units 511 and 521 of the first frame 510 and the second frame 520 of the first coupling unit 500.

Thereafter, after the third frame 530 of the first coupling unit 500 is pushed between the first frame 510 and the second frame 520, the third frame 530 couples the edge unit 432 of the third manifold 430 to the upper end plate 200 and the lower end plate 300 using the fastening bolts 571 and 581 of the third fastening member 570 and the fourth fastening member 580 of the first coupling unit 500. In this case, since the insertion groove 531a is formed in the third frame 530, the third frame 530 is laterally inserted into the fastening bolt 561 of the second fastening member 560, and the wing units 532 are outwardly bent at both ends of the third frame 530. Accordingly, both ends of the third frame 530 may be coupled to the first frame 510 and the second frame 520 without interfering with the first frame 510 and the second frame 520.

Thereafter, the first frame 610, the second frame 620, and the third frame 630 of the second coupling units 600 are coupled to respective adjacent frames using the first fastening member 650, the second fastening member 660, and the third fastening member 670 of the second coupling units 600. In this case, the first support faces 641a and 643a provided in the first connection block 641 of the second coupling unit 600 closely attach the edge units of the middles of the first manifold 410 and the second manifold 420 to the stack 100, thereby coupling the first manifold 410 and the second manifold 420. Furthermore, the second support faces 641b and 643b are supported to the entrance side of the cathode of the stack 100 so that the third manifold 430 is closely attached and coupled to the exit side of the cathode of the stack 100.

In this case, a difference in thermal deformation between the stack and the manifolds can be flexibly handled because the fastening members that couple the manifolds to the stack are coupled to the manifolds in such a way as to come in a direct contact with the manifolds. Furthermore, a reduction of the binding force of the fastening member can be minimized because the fastening member is configured to have a specific cross-sectional area so that it is not easily thermally deformed according to a change of an environment.

Furthermore, the influence of a reduction in the binding force on a specific frame while the fuel cell operates can be prevented from being transferred to other frames because some frames of the first coupling unit are coupled independently of other frames. Accordingly, the coupling states of the stack and the manifolds can be prevented from continuously becoming poor, and thus the performance of the fuel cell can be prevented from being suddenly reduced.

1-13. (canceled)

14. A fuel cell equipped with coupling devices, including:
a stack in which a plurality of unit cells having an anode and a cathode is stacked in a height direction;
an upper end plate and a lower end plate provided at both upper and lower ends of the stack;
a plurality of manifolds closely attached and coupled to sides of the stack so that fuel and air supplied to the stack are distributed into the unit cells;
first coupling units that closely attach the manifolds to the upper end plate and the end lower plate; and/or
second coupling units that closely attach the manifolds to the stack.

15. The fuel cell of claim 14, wherein the first coupling units comprise:
a plurality of frames detachable from the manifolds and
fastening members that interconnect the plurality of frames.

16. The fuel cell of claim 15, wherein the fastening members are coupled to both ends of one of the plurality of frames so that the one frame is coupled independently of other frames.

17. The fuel cell of claim 16, wherein support units bent in a direction in which two frames of the plurality of frames other than the independently coupled frame face each other are formed at ends of each of the two frames.

18. The fuel cell of claim 17, wherein both ends of the frame having the support units are coupled by a fastening member that passes through both sides of the end plate.

19. The fuel cell of claim 18, wherein an insertion groove is formed in the independently couple frame so that a fastening bolt forming the fastening member is inserted into the insertion groove.

20. The fuel cell of claim 16, wherein:
wing units bent outwardly from the end plate are formed on at least one of both ends of the independently coupled frame and an end of a frame corresponding to the independently coupled frame, and
fastening members are coupled to the respective wing units.

21. The fuel cell of claim 20, wherein the wing units are diagonally bent and formed so that inside surfaces of adjacent frames correspond to each other.

22. The fuel cell of claim 21, wherein the fastening members coupled to the wings units are coupled to the sides of the end plates in a straight line.

23. The fuel cell of claim 15, wherein the fastening members comprise:
respective fastening bolts that connect the plurality of frames;
respective coupling nuts coupled to one ends of the fastening bolts; and
respective fastening springs provided between the frames and the coupling nuts, for elastically supporting the manifolds and the sides of the upper end plate.

24. The fuel cell of claim 14, wherein the second coupling unit comprises:
a plurality of frames fixed to the manifolds; and
a fastening member that interconnects the plurality of frames.

25. The fuel cell of claim 24, wherein the second coupling unit comprise:
a plurality of frames comprising a pair of bars fixed to outside surfaces of the manifolds and spaced apart from each other;
connection blocks installed at both ends of the frame and connecting the plurality of frames; and
fastening members coupling the connection blocks.

26. The fuel cell of claim 25, wherein at least one support face is formed in at least one of the connection blocks so that the at least one support face is directly brought in contact with and supported to the stack or the manifolds.

27. The fuel cell of claim 25, wherein:
a plurality of support faces is formed in at least two of the connection blocks, and
each of the plurality of support faces is formed at a right angle.

28. The fuel cell of claim 25, wherein a cross-sectional area of the bar is formed to be smaller than a cross-sectional area of each frame of the first coupling unit.

29. The fuel cell of any one of claim 14, wherein:
the manifolds are installed on the entrance side and exit side of the anode and the exit side of the cathode of the stack,
each of the manifolds comprises a housing unit that accommodates the entrance and exit of the anode and the exit of the cathode,
an edge of the housing unit has an edge unit so that the edge comes in contact with the stack, the upper end plate, and the lower end plate,
the housing unit is supported by the second coupling unit, and
the edge unit is supported by the first coupling unit.

30. The fuel cell of claim 29, wherein the entrance side of the cathode connects the entrance side and exit side of the anode using a single fastening member.

31. A coupling method in a fuel cell, comprising steps of:
coupling edge units of up and down sides of the manifolds to an upper end plate and a lower end plate using a first coupling unit; and
coupling a housing unit of the manifolds to a stack using a second coupling unit,
wherein the steps are simultaneously performed or sequentially performed regardless of order of the steps.

32. The coupling method of claim 31, wherein the step of coupling edge units of up and down sides of the manifold to an upper end plate and a lower end plate using a first coupling unit comprises steps of:
disposing a first manifold, a second manifold, and a third manifold in an entrance/exit of an anode and in an exit of a cathode and closely attaching a first support unit of a first frame and a first support unit of a second frame of the first coupling unit to an upper edge unit and lower edge unit of each of the first manifold and the second manifold;
coupling both upper and lower sides of the first manifold and the second manifold to the upper end plate and the lower end plate through the first support units of the first frame and the second frame using fastening bolts of a first fastening member and fastening bolts of a second fastening member of the first coupling unit; and
pushing a third frame of the first coupling unit between the first frame and the second frame and coupling edge units of the third manifold to the upper end plate and the lower end plate through the third frame using the fastening bolts of a third fastening member and fourth fastening member of the first coupling unit.

33. The coupling method of claim 31, wherein:
the step of coupling a housing unit of the manifolds to the stack using a second coupling unit comprises a step of connecting the first frame, second frame, and third frame of the second coupling unit to adjacent frames using the first fastening member, the second fastening member, and the third fastening member;
first support faces provided in a first connection block and third connection block of the second coupling unit closely attach the edge units of the first manifold and the second manifold to the stack, thereby coupling the first manifold and the second manifold; and
second support faces provided in the first connection block and the third connection block are supported to the entrance side of the cathode of the stack, thereby closely attaching and coupling the third manifold to the exit side of the cathode of the stack.
